(19) United States
(12) Patent Application Publication
(10) Pub. No.: US 2020/0088268 A1
(43) Pub. Date: Mar. 19, 2020

(54) ACTUATOR WITH SPEED REDUCER

(71) Applicant: GENESIS ROBOTICS AND MOTION TECHNOLOGIES CANADA, ULC, Langley (CA)

(72) Inventor: James Brent KLASSEN, Surrey (CA)

(73) Assignee: GENESIS ROBOTICS AND MOTION TECHNOLOGIES CANADA, ULC, Langley (CA)

(21) Appl. No.: 16/616,493

(22) PCT Filed: May 31, 2018
(86) PCT No.: PCT/CA2018/050646

§ 371 Date: Nov. 25, 2019

Related U.S. Application Data
(60) Provisional application No. 62/513,431, filed on May 31, 2017.

(51) Int. Cl. F16H 3/72; F16H 1/28; H02K 7/116

(52) U.S. Cl. CPC F16H 3/724; H02K 7/116; F16H 1/2863

(57) ABSTRACT

An electromagnetic actuator having a speed reducer has a stator and a rotor arranged to move rotationally relative to the stator. A drive gear is fixed to the rotor. At least three planetary gears are mounted on the stator and each of the at least three planetary gears are engaged by the drive gear. An annular gear is rotationally mounted on the first stator the annular gear is engaged by each of the at least three planetary gears.

### TECHNICAL FIELD

An electromagnetic actuator having a speed reducer

### CROSS-REFERENCE TO RELATED APPLICATIONS

This application is a non-provisional application that claims priority from U.S. Provisional Patent Application No. 62/513,431 entitled “Torque Amplifier”, filed on May 31, 2017. The application listed above is incorporated by reference herein in its entirety.

### BACKGROUND

Eliminating backlash from a gearbox is very challenging because rigidly preloading conventional gears against each other can cause them to bind during thermal expansion while spring loading gears against each other requires the maximum torque preload at all times, leading to high friction and wear during low load conditions.

### SUMMARY

In an embodiment, there is disclosed a low ratio speed reducer in combination with a high torque motor, which can be of benefit in a robotic or motion control application, because it allows a high level of backdrivability and higher output speed than a high ratio gearbox. When paired with a high torque motor, such as the LiveDrive™ motor for example as disclosed in International Publication No. WO/2017/024409 and related applications, it can also provide very high torque with a high torque-to-inertia ratio.

In an embodiment there is a gear reduction device disclosed that provides high backdrivability and low friction during low load conditions with zero backlash at all times even during high torque.

In an embodiment there is an axial flux rotor sandwiched between two stators with the back of a stator rotationally securing one or more planet gears and an annulus output gear. The use of a solid material for this stator makes it possible to fabricate the stator with the planet shafts (or planet shaft bores) as one piece with the stator. This has advantages in terms of torque, precision and cost reduction. The planet gears do not orbit, as with a common planetary gearbox. Instead, the planet gear axes are fixed in relation to the stator and act as idler pulleys between the sun gear input and the annular ring gear output. This eliminates the need for a rotating planet carrier and its associated cost, complexity, and potential for lost motion.

In an embodiment there is electromagnetic actuator having a speed reducer. There is a first stator and a rotor arranged to move rotationally relative to the first stator. A drive gear is fixed to the rotor. At least three planetary gears are mounted on the first stator and each of the at least three planetary gears are engaged by the drive gear. An annular gear is rotationally mounted on the first stator the annular gear is engaged by each of the at least three planetary gears.

In another embodiment there is a gear assembly having a first gear and a second gear, each of the first and second gears having a plurality of teeth, each of the plurality of teeth having a length and an addendum along the length of each tooth. Each tooth is tapered along its length and the addendum varies in relation to the taper along the length of each tooth. The first gear and second gear fit into engaging position when a positive shift face of the first gear engages a negative shift face of the second gear.

### BRIEF DESCRIPTION OF FIGURES

Embodiments of an electromagnetic actuator having a speed reducer will now be described by way of example, with reference to the figures, in which like reference characters denote like elements, and in which:

FIG. 1 is a cutaway view showing the gears in an electromagnetic actuator with an annulus gear.

FIG. 2 is an isometric side view of the planetary gears and annular gear of an electromagnetic actuator.

FIG. 3 is a cross-section of a tapered gear body.

FIG. 4 is an isometric view of a gear tooth profile of a tapered gear body with constant diametral pitch.

FIG. 5 is a cross-section of a gear tooth through the section 5-5 in FIG. 4.

FIG. 6 is a cross-section of a gear tooth through the section 6-6 in FIG. 4.

FIG. 7 is a cross-section of a gear tooth through the section 7-7 in FIG. 4.

FIG. 8 is a partial cut-away view of a spring biased planetary gear.

FIG. 9 is a cross-section of an actuator with magnets for preloading the planetary gears.

FIG. 10 is a partial cut-away view of an actuator with openings to allow for cooling.

FIG. 11 is an isometric view of a tapered gear.

FIG. 12 is an isometric front view of a tapered gear.

FIG. 13 is a representative sketch of a positive addendum shift profile for the teeth of a gear.

FIG. 14 is an isometric front view of a tapered gear showing the addendum profile of the back of a tooth.

FIG. 15 is an isometric front view of a tapered gear showing the addendum profile of the middle of a tooth.

FIG. 16 is an isometric front view of a tapered gear showing the addendum profile of the front of a tooth.

### DETAILED DESCRIPTION

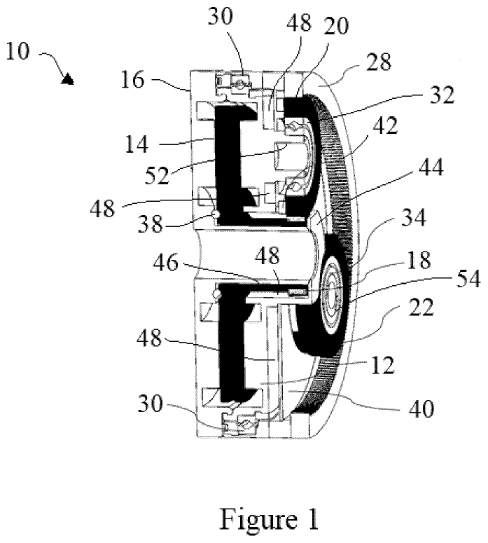

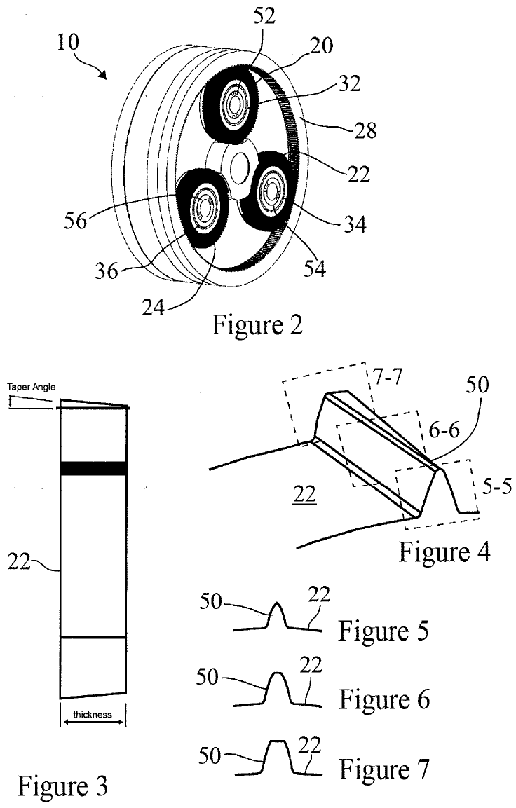

As shown in FIGS. 1 and 2, an electromagnetic actuator 10 having a speed reducer includes at least a first stator 12 and a rotor 14 arranged to move rotationally relative to the first stator 12. As shown, the first stator 12 may be one of two stators 12, 16 fixed together and the rotor 14 is arranged between the two stators and moves rotationally relative to each of the two stators. The rotor 14 and stator 16 may be mounted on bearings 38. Although both stators are shown in FIG. 1, it is possible for only a single stator to be used. The term ‘first stator’ is used to describe the stator that supports an annular gear, or annulus gear, 28. In the claims, the term ‘first stator’ does not exclude the possibility that only a single stator is present. A drive gear 18, or sun gear, is fixed to a shaft 46 of the rotor. Three planetary gears 20, 22, 24 are mounted on the first stator 12 and each of the three planetary gears are engaged by the drive gear 18. In other embodiments, other numbers of planetary gears could be used, including four or more. The annular gear 28 is rotationally mounted on the first stator 12. The annular gear 28 is engaged by each of the three planetary gears 20, 22, 24. The three planetary gears 20, 22, 24 are each mounted on one of three posts 52, 54, 56 that are formed as part of the same monolithic material as the first stator 12. The annular gear 28 is affixed to the first stator 12 by bearings 30. The drive gear 18 may be hidden under a cap 44.

The three planetary gears 20, 22, 24 each have a plurality of teeth that engage corresponding teeth on the annular gear 28 and the drive gear 18. Each of the teeth 50 (FIG. 4) have a length and each of the teeth is tapered along the length as shown in FIG. 4. Each of the three planetary gears may be axially preloaded.

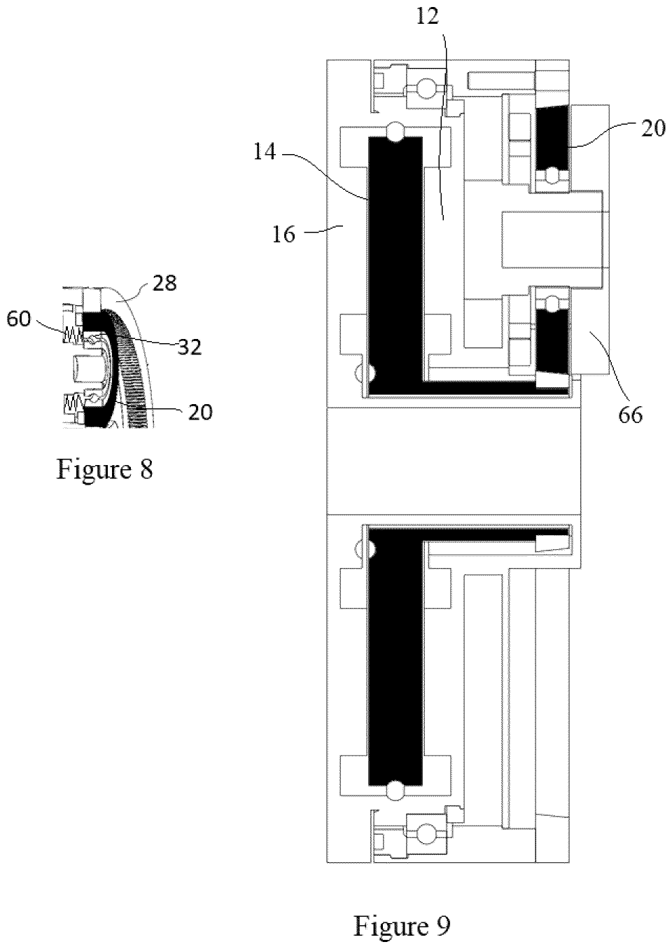

As shown in FIG. 8, the three planetary gears 20, 22, 24 may each be axially preloaded by a corresponding spring, such as spring 60 acting on the corresponding bearing 32 between the three planetary gear 20 and the first stator 12.

As shown in FIG. 9, the three planetary gears, such as planetary gear 20 may be axially preloaded by a corresponding magnet 66.

Referring to FIG. 1, three electromagnetic coils, such as magnetic coil 42, may be fixedly mounted on the stator 12 to provide axial movement of the three planetary gears 20, 22, 24 relative to the drive gear 18 and the annular gear 28. The position of the electromagnetic coil 42 relative to the planetary gear 20 is the same as the positions of the other two electromagnetic coils relative to planetary gears 22 and 24. The three electromagnetic coils 42 may be actuated by a first electric current set by a pulse-width modulation controlled energization. The stator 12 and rotor 14 form an axial flux motor actuated by a plurality of electromagnetic coils and permanent magnets. For example, the first stator 12 may include a plurality of electromagnetic coils actuated by a second electric current and the rotor 14 may include a plurality of permanent magnets. The three electromagnetic coils 42 may be actuated by the first electric current that is proportional to the second electric current. The drive gear 18 may be made from spinodal bronze or other suitable material. The annular gear 28 may also be made from spinodal bronze or other suitable material.

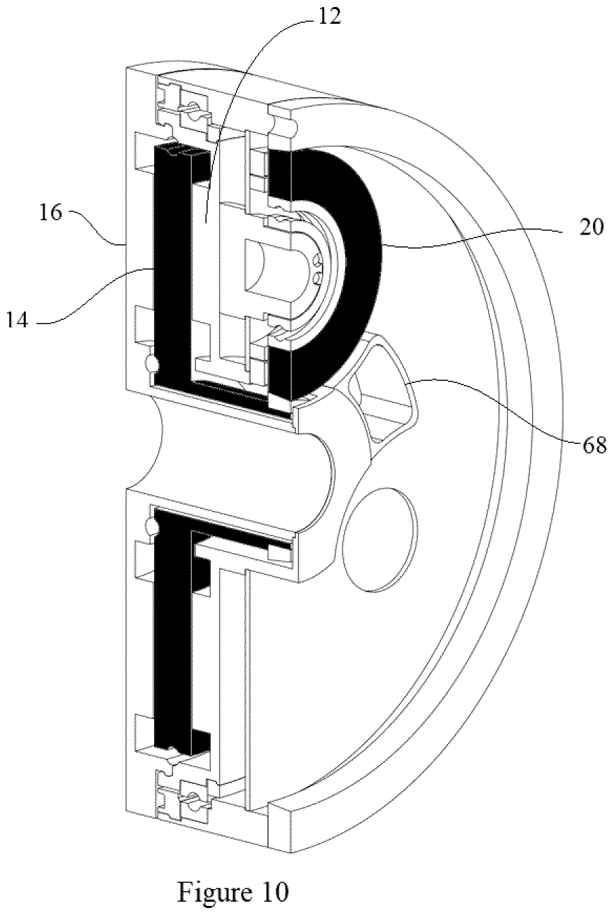

As shown in FIG. 10, the first stator 12 further comprises openings 68 to direct air flow through the actuator 10 during operation.

The three planetary gears 20, 22, 24 are connected to each of the three posts 52, 54, 56 by three planetary bearings 32, 34, 36 sitting between an inner diameter of each of the three planetary gears and an outer diameter of each of the three posts. The three planetary bearings 32, 34, 36 each comprise a row of ball bearings sitting on an inner groove integral to the outer diameter of each of the at least three posts and on an outer groove integral to the inner diameter of each of the at least three planetary bearings. The row of ball bearings may also sit between sleeves on the three planetary gears 20, 22, 24 and the three posts 52, 54, 56.

The three planetary bearings 32, 34, 36 are arranged to allow a small amount of movement in a radial direction relative to each of the at least three planetary gears 20, 22, 24.

The annular ring gear 28 is rotationally attached to the stator 12 with a bearing 30 around the OD and/or ID. Spinning the rotor 14 spins the sun gear 18 which is fixed to the rotor structure 12. Rotation of the sun gear 18 causes the idler planet gears 20, 22, 24 to rotate which, in turn, causes the annular gear, or annulus gear, 28 to rotate.

Straight or helical cut gears can be used in this gear train. Various known gear interface preloading arrangements can be used to reduce or eliminate backlash. Disclosed here is a unique gear preload arrangement which allows the preload to be adjusted according to the torque load that is being transmitted through the drive.

In an embodiment, the addendum and dedendum of the sun, planets and annulus are adjusted such that a tapered tooth effect is achieved without changing the aspect ratio. The details of this are described as follows and as shown in FIGS. 3 to 7. The dedendum and addendum of the sun, planets, and annulus at the top of the taper and at the bottom of the taper were determined using the change in the diameter required for a prescribed taper angle and gear body thickness. FIG. 5 shows a cross-section of the front of the tooth 50. FIG. 6 shows a cross-section of the middle of the tooth 50. FIG. 7 shows a cross-section of the back of the tooth 50. The teeth and preload work together to eliminate backlash. The preload, whether created by a spring, magnet or electromagnetic or other biasing means, will pull the teeth so that the tapers of the corresponding teeth are brought into an engaging contact. The preload can push the planetary gears away from the stator and other gear or pull the planetary gears towards the stator and other gears, depending on the orientation of the corresponding tapers. It is preferable to have the planetary gears pulled towards the stator for assembly purposes.

The taper angle of the body was selected in coordination with the materials of which the gears were comprised such that the taper angle ensured the highest possible axial load but remained outside of the region considered self-locking.

The pitch diameter of the sun, planets, and annulus gears was constant across the thickness of the gear body, respectively. A pure mathematical involute was used for the teeth on each of the gears in order to ensure zero backlash would originate as a result of the tooth profile.

For each of the sun, planets, and annulus gears, the change in the addendum and dedendum due to the taper of the gear body resulted in variation of the tooth profile as different sections of the mathematical involute were used.

In the configurations shown in FIGS. 2 and 3, axial force on the planets 20, 22, 24 increases the axial preload on the tapered gear interface, removing backlash form the device.

As shown in FIG. 8, this preload may be provided by a spring acting on the bearing.

As shown in FIG. 9, this preload may be provided by a permanent magnet acting on the planet. This can be by a ferrous planet material and a fixed permanent magnet attached to the housing. It can also be achieved by permanent magnets imbedded in the gear which attract to a ferrous material on the housing or other member.

The annulus 28 and sun 18 are preferably fixed in the axial direction but they could be axially movable in some configurations.

As shown in FIG. 1, in a preferred embodiment, magnetic coils 42 are used to pull the planet gears 20, 22, 24 in the axial direction. In this embodiment, the taper angle of the gears is such that the maximum torque provided by the sun gear results in an axial force on the planets 20, 22, 24 that is less than the maximum electromagnetic force between the attraction coils 42 and the planets. The lower the taper angle, the lower the magnetic force needed. If the taper angle is too low, however, precision may need to be too high to maintain a consistent axial location of the planets.

Spring or magnetic preload may be used to maintain zero backlash operation when not powered, and to reduce the power and magnetic force required from the attraction coils.

The use of spinodal bronze for one or more of the gears is desirable to eliminate the need for lubrication. Spinodal bronze has the unique characteristic of coating the mating surface with a semi-solid lubricant that reduces friction and wear. By using spinodal bronze for the sun gear and possibly the annulus gear (although this would be more expensive) it may be possible to coat the steel planet gears with solid lubricant for a non-lubricated gearbox.

The present device requires that the planet gears are allowed to move axially to take up backlash. This creates a challenge because an axially sliding mechanism on these gears would introduce a clearance in the load path that would lead to lost motion when the torque reverses. Embodiments of the device use a rolling element bearing arrangement that allows axial movement of the planet gears 20, 22, 24 and their bearings 32, 34, 36, while eliminating any play in the load path. This bearing arrangement also allows a small amount of radial movement of the planet gears which is necessary to provide consistent preload of the planet gear teeth against the sun gear and annular ring gear. In this bearing arrangement, a bearing groove on both tangential sides of a planet bearing shaft has a row of ball bearings that roll between and against the groove and the ID of the planet gear inner bearing race (or sleeve inside the bearing race). The use of spherical rolling elements on just the circumferential sides of the planet shafts, allows the planet gears to move axially and a small amount radially outward from the sun gear. By using rolling elements it is possible to preload these bearings in such a way that all of the play is taken out of this interface. The planet gear cartridge bearings which may be press fit into the gear ID, can also be preloaded by the elastic deformation of the inner race which may be forced outwards in two places (in the circumferential direction relative to the sun gear axis) such that all play is taken out of the cartridge bearing in the circumferential directions, but not in the radial direction (relative to the sun gear). This provides a situation where the cartridge bearing and the two sets of circumferentially locating bearings both reduce or eliminate play in the circumferential direction (relative to the sun gear) which provides a zero backlash and zero lost motion in the load path from sun gear through the planets and planet bearings to the ring gear. At the same time, the cartridge bearing and the two sets of circumferentially locating bearings allow a small amount of movement in the radial direction (relative to the sun gear) which allows the planet gears to settle into the appropriate radial position so the axial force on the planets (provided by any means, such as springs and or magnetic force) will remove all backlash from the planet interaction with the sun gear and the ring gear over the full range of loads.

To operate the above device with electromagnetic planet gear preload, a predetermined electromagnetic force and corresponding current (such as can be set by a PWM controlled energization) is sent to the planet preload coils 42. This preload current will be proportional to the current level being sent to the motor, so the axial preload on the planets to prevent backlash will always be higher (but preferably only slightly higher) than the axial force which would cause the opposite axial movement of the planets, which results from torque being transferred through the gearbox. In this way, the axial preload on the planets, which, for example, results in increased friction at high torque loads, can be reduced down to very low levels of friction at low torque loads to achieve a highly backdrivable gearbox with reduced wear because the gears are only highly preloaded in the axial direction when high torque is required from them.

In order to dissipate heat within the assembly, a fluid such as air may be moved through the regions enclosed by the parts and directed over the magnetic coils. In some embodiments a separator plate 40 or a series of separator plates may be used to direct the flow within and through the assembly. Optionally, the flow of a cooling fluid may be pushed or drawn into the assembly and specific configurations of orifice openings 68 (FIG. 8) can be applied in each scenario in order to manifold the airflow based on the flow direction and static pressure within the assembly. The orifice openings may allow cooling to occur in optional cooling regions 48 (FIG. 1). Optional placement of the cooling regions can include adjacent to the electromagnetic coils, adjacent to the rotor shaft 46 and between the stator 12 and the separator plate 40.

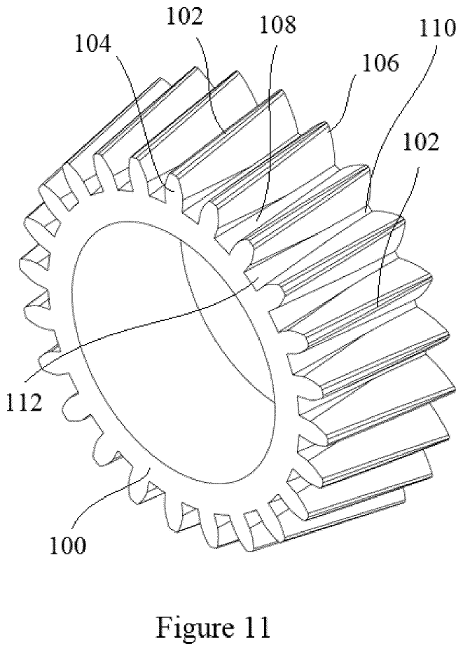

FIGS. 11 to 16 show an embodiment and design of a tapered gear tooth profile. The design of the gear shown may be used with the actuator shown in FIG. 1 or in other applications.

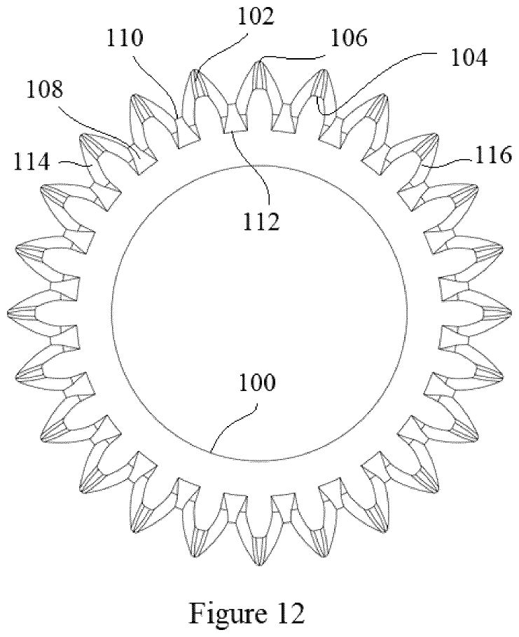

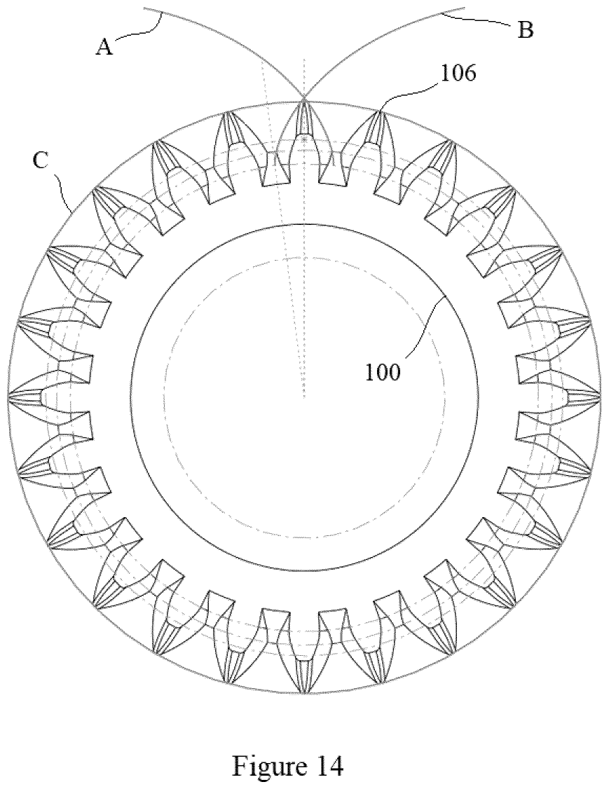

As shown in FIGS. 11 and 12, there is a gear 100 having a plurality of teeth 102. The teeth are tapered so that a back end 106 of each tooth extends radially outward from the central axis of the gear further than a front end 104 of each tooth. Similarly, gaps 108 between each tooth are tapered. A back end 110 of each gap extends radially outward from the central axis of the gear further than a front end 112 of each gap. The addendum of each tooth, as defined by its sides 114 and 116 are shifted in accordance with the taper, as shown in more detail in FIGS. 14 to 16.

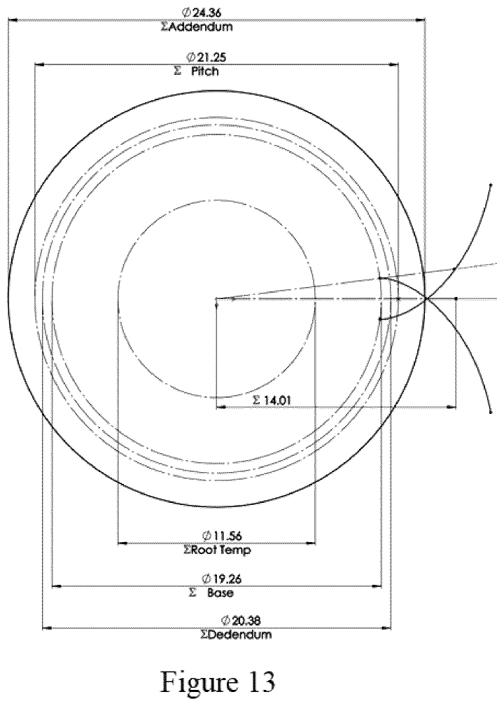

FIG. 13 shows an exemplary sketch of a positive addendum shift profile and labeled notable diameters including addendum, pitch, base and dedendum diameters.

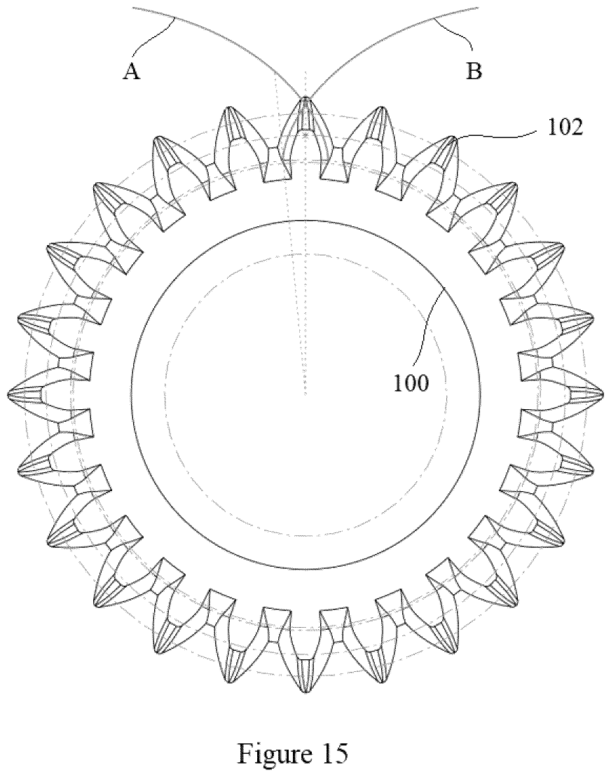

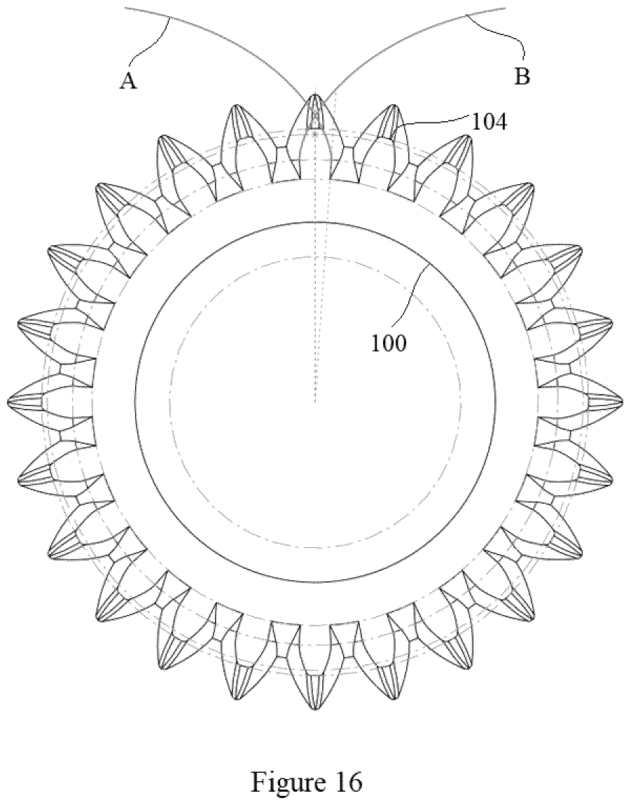

FIGS. 14 to 16 show the gear tooth profile at three points along the length of a tooth. FIG. 14 shows the shape of the addendum defined by lines A and B through the back 106 of each tooth. FIG. 15 shows the shape of the addendum defined by lines A and B through the middle of each tooth 102. FIG. 16 shows the shape of the addendum defined by lines A and B through the front 104 of each tooth. The midplane is used to define the tooth profile in its standard configuration. On either axial end of the gear, an addendum shift is completed, shifting the gear tooth upward or downward. Between these three planes, there is a linear interpolation of the gear tooth.

Typically, an addendum shift is completed across the whole gear length. By varying the addendum shift across the length of the tooth, and combining a conical taper of the gear tooth body, a tapered gear is created. When combined with a second tapered gear, using the same addendum shifts, the two gears mesh when the positive shift face of one gear meets the negative shift face of the other.

A tapered gear allows preloading by applying an axial load to the gear. This has the effect of eliminating backlash between the gears. Additionally, it allows a gear to be more easily injection moulded.

Although the foregoing description has been made with respect to preferred embodiments of the present invention it will be understood by those skilled in the art that many variations and alterations are possible. Some of these variations have been discussed above and others will be apparent to those skilled in the art. For example, when various components are described herein as being fixed or mounted or fixedly mounted to certain other components, it will be understood that those components may be fixed directly or indirectly to the components described. The addition of intervening connecting pieces which are also fixed between the components does not change whether the original two components are considered to be fixed to each other. For example, as shown in FIG. 1, although the planetary gears 20, 22 and 24 are shown fixed to a separator plate 40, the planetary gears are nonetheless described as being mounted on the stator, since the separator plate 40 is itself fixed to the stator and acts as if it were part of the stator.

In the claims, the word “comprising” is used in its inclusive sense and does not exclude the possibility of other elements being present. The indefinite article “a/an” before a claim feature does not exclude more than one of the feature being present unless it is clear from the context that only a single element is intended.

1. An electromagnetic actuator having a speed reducer, comprising:
a first stator; a rotor arranged to move rotationally relative to the first stator; a drive gear fixed to the rotor; at least three planetary gears mounted on the first stator and each of the at least three planetary gears being engaged by the drive gear; and an annular gear rotationally mounted on the first stator the annular gear being engaged by each of the at least three planetary gears, wherein the at least three planetary gears are each mounted on one of at least three posts that are formed as part of the same monolithic material as the first stator.

2. (canceled)

3. The actuator of claim 1 in which the first stator is one of two stators fixed together and the rotor is arranged between the two stators and moves rotationally relative to each of the two stators.

4. The actuator of claim 3 in which the annular gear is affixed to the first stator by bearings.

5. The actuator of claim 1 in which the at least three planetary gears each have a plurality of teeth, each of the teeth having a length and each of the teeth being tapered along the length.

6. The actuator of claim 1 in which each of the at least three planetary gears is axially preloaded.

7. The actuator of claim 6 in which each of the at least three planetary gears is axially preloaded by a corresponding spring acting on a corresponding bearing between each of the at least three planetary gears and the first stator.

8. The actuator of claim 7 in which each of the at least three planetary gears is axially preloaded by a corresponding magnet.

9. The actuator of claim 1 further comprising at least three electromagnetic coils fixedly mounted to the first stator adjacent to the at least three planetary gears to provide axial movement of the at least three planetary gears relative to the drive gear and the annular gear.

10. The actuator of claim 9 in which the at least three electromagnetic coils are actuated by a first electric current set by a pulse-width modulation controlled energisation.

11. The actuator of claim 10 in which the first stator comprises a plurality of electromagnetic coils actuated by a second electric current and the rotor comprises a plurality of permanent magnets, and in which the at least three electromagnetic coils are actuated by the first electric current that is proportional to the second electric current.

12. The actuator of claim 1 in which the drive gear further comprises spinodal bronze.

13. The actuator of claim 1 in which the annular gear further comprises spinodal bronze.

14. The actuator of claim 1 in which the stator further comprises openings to direct fluid flow through the actuator during operation.

15. The actuator of claim 1 in which each of the at least three planetary gears is connected to each of the at least three posts by a corresponding one of at least three planetary hearings sitting between an inner diameter of the one of the at least three planetary gears and an outer diameter of the one of the at least three posts.

16. The actuator of claim 15 in which each of the at least three planetary bearings comprise a row of ball bearings sitting on an inner groove integral to the outer diameter of each of the at least three posts and on an outer groove integral to the inner diameter of each of the at least three planetary bearings.

17. The actuator of claim 15 in which each of the at least three planetary bearings are arranged to allow a small amount of movement in a radial direction relative to each of the at least three planetary gears.

18. A gear assembly, comprising: a first gear and a second gear, each of the first and second gears having a plurality of teeth, each of the plurality of teeth having a length and an addendum defined along the length of each tooth, in which each tooth is tapered along its length and the addendum varies in relation to the taper along the length of each tooth and in which the first gear and second gear fit into engaging position when a positive shift face of the first gear engages a negative shift face of the second gear.

19. The gear assembly of claim 18 in which the addendum shift along the length of each tooth is linearly correlated with the taper along the length of the tooth.

20. The gear assembly of claim 18 in which the first and second gears are axially preloaded into contact with each other.

21. The gear assembly of claim 18 in which at least one of the first and second gear is axially preloaded using electromagnetic coils placed adjacent to the respective preloaded gear.
